(19) United States
(12) Patent Application Publication
(10) Pub. No.: US 2022/0301741 A1
(43) Pub. Date: Sep. 22, 2022

(54) INTUMESCENT FLAME-RETARDANT COILED MATERIAL FOR CABLES AND INTUMESCENT FLAME-RETARDANT CABLE

(71) Applicant: 3M INNOVATIVE PROPERTIES COMPANY, St. Paul, MN (US)

(72) Inventors: Wei Zhou, Shanghai (CN); Zheng Guan, Shanghai (CN)

(21) Appl. No.: 17/633,032

(22) PCT Filed: Aug. 14, 2020
(86) PCT No.: PCT/IB2020/057677

§ 371 Date: Feb. 4, 2022

(30) Foreign Application Priority Data
Aug. 15, 2019 (CN) 201921324522.1

(51) Int. Cl. H01B 7/295; H01B 3/47

(52) U.S. Cl. CPC H01B 7/295; H01B 3/47

(57) ABSTRACT

The present application provides an intumescent flame-retardant coiled material for cables and an intumescent flame-retardant cable. Specifically, the intumescent flame-retardant coiled material for cables comprises a thermal expansion layer and a combustible armor layer adjacent to the thermal expansion layer. The intumescent flame-retardant cable comprises a cable core; a thermal expansion layer adjacent to the cable core; and a combustible armor layer adjacent to the thermal expansion layer. The intumescent flame-retardant coiled material can be used for mounted and curved cables and can provide excellent flame-retardant performance while providing effective mechanical protection for cables.

### TECHNICAL FIELD

The present application relates to the technical field of cables, in particular to an intumescent flame-retardant coiled material for cables and an intumescent flame-retardant cable.

### BACKGROUND

At present, various cables are widely applied in the electrical field. On one hand, cables need to have necessary mechanical performance to provide mechanical protection. On the other hand, various reasons for risk of fire exist when cables are in use, thus fireproof performance becomes increasingly important. Electric utility companies are seeking ways to increase the fireproof performance of their installed assets. In order to achieve the above purpose, at present a non-flexible structure (i.e., rigid protection structure) is usually adopted to provide localized protection to cables and/or cable splices. However, the above method is generally not applicable to mounted and curved cables or for extended cable sections (i.e. over 1-2 meters in length).

Therefore, it is of great significance to develop a protective material applicable to mounted cables or cable splices, curved cables, and/or extended lengths of cables that provides satisfactory mechanical protection performance and flame-retardant performance.

### SUMMARY

One purpose of the present application is to provide a protective material applicable to mounted and curved cables and having satisfactory mechanical protection performance and flame-retardant performance. Another purpose of the present application is to provide a protective material applicable to installed cable splices to improve mechanical protection performance and flame-retardant performance, and yet another purpose of the present application is to provide a protective material that can be easily applied to longer continuous lengths of cables.

Specifically, the present application provides an intumescent flame-retardant coiled material which can be applied to installed cables and cable splices. The intumescent flame-retardant coiled material for cables comprises a thermal expansion layer and a combustible armor layer adjacent to the thermal expansion layer, wherein the thermal expansion layer is a phosphate thermal expansion layer, a melamine thermal expansion layer, a ceramic fiber thermal expansion layer, or an expandable graphite thermal expansion layer, and wherein the combustible armor layer is an organic fiber combustible armor layer or a knitted fiberglass layer impregnated with a polyurethane resin.

According to some preferred embodiments of the present application, thickness of the thermal expansion layer is in a range from 1 mm to 20 mm.

According to some preferred embodiments of the present application, thickness of the combustible armor layer is in a range from 1 mm to 10 mm.

According to some preferred embodiments of the present application, the combustible armor layer is a knitted fiberglass layer impregnated with a polyurethane resin.

According to some preferred embodiments of the present application, a metal wire layer is further provided between the thermal expansion layer and the combustible armor layer.

According to some preferred embodiments of the present application, two groups of metal wires parallel to each other in the metal wire layer are arranged crossing with each other.

According to some preferred embodiments of the present application, metal wires parallel to each other in the metal wire layer are arranged in a Z-shape without crossing with each other.

According to some preferred embodiments of the present application, the diameter of a metal wire in the metal wire layer is in a range from 0.01 mm to 0.5 mm.

According to some preferred embodiments of the present application, an average spacing between two adjacent parallel metal wires in the metal wire layer is in a range from 2 mm to 10 mm.

Another purpose of the present application is to provide an intumescent flame-retardant cable having effective mechanical protection performance and excellent flame-retardant performance. Specifically, the intumescent flame-retardant cable comprises a cable core; a thermal expansion layer adjacent to the cable core; and a combustible armor layer adjacent to the thermal expansion layer, wherein the thermal expansion layer is a phosphate thermal expansion layer, a melamine thermal expansion layer, a ceramic fiber thermal expansion layer, or an expandable graphite thermal expansion layer, and wherein the combustible armor layer is an organic fiber combustible armor layer or a knitted fiberglass layer impregnated with a polyurethane resin.

Another purpose of the present application is to provide an intumescent flame-retardant covering for a cable splice or other installed asset having effective mechanical protection performance and excellent flame-retardant performance. Specifically, the intumescent flame-retardant cable splice comprises a cable splice; a thermal expansion layer adjacent to the cable splice; and a combustible armor layer adjacent to the thermal expansion layer.

According to some preferred embodiments of the present application, thickness of the thermal expansion layer is in a range from 1 mm to 20 mm.

According to some preferred embodiments of the present application, thickness of the combustible armor layer is in a range from 1 mm to 10 mm.

According to some preferred embodiments of the present application, the combustible armor layer is a knitted fiberglass layer impregnated with a polyurethane resin.

According to some preferred embodiments of the present application, a metal wire layer is further provided between the thermal expansion layer and the combustible armor layer.

According to some preferred embodiments of the present application, two groups of metal wires parallel to each other in the metal wire layer are arranged crossing with each other.

According to some preferred embodiments of the present application, metal wires parallel to each other in the metal wire layer are arranged in a Z-shape without crossing with each other.

According to some preferred embodiments of the present application, the diameter of a metal wire in the metal wire layer is in a range from 0.01 mm to 0.5 mm.

According to some preferred embodiments of the present application, an average spacing between two adjacent parallel metal wires in the metal wire layer is in a range from 2 mm to 10 mm.

The term “intumescent flame-retardant coiled material” is a material comprising an intumescent layer and an armor layer wherein the armor layer can be a sacrificial/combustible layer. It is surprising that the intumescent flame-retardant coiled material provides flame protection to a cable or other asset wrapped with the material when one of the layers may be flammable. Thus, cable or other asset will be protected, even though the intumescent flame-retardant coiled material may not be flame-retardant.

The intumescent flame-retardant coiled material for cables and the intumescent flame-retardant cable according to the present application have the following advantages:

1. The combustible armor layer has good mechanical performance and can provide good mechanical protection for the cable;

2. The combustible armor layer burns horizontally in the direction parallel to the cable length direction when burning under heating, effectively activating the expansion of the thermal expansion layer and improving the flame-retardant performance; and

3. The intumescent flame-retardant coiled material can be directly applied to mounted and curved cables or extended lengths of cables.

4. The intumescent flame-retardant coiled material can be directly applied onto mounted or installed cable splices.

### BRIEF DESCRIPTION OF THE DRAWINGS

FIG. 1 illustrates a cross-sectional view of an intumescent flame-retardant coiled material according to one embodiment of the present application;

FIG. 2 illustrates a cross-sectional view of an intumescent flame-retardant coiled material according to another embodiment of the present application;

FIG. 3 illustrates top perspective views A and B of an intumescent flame-retardant coiled material for cables according to one embodiment of the present application;

FIG. 4 illustrates a cross-sectional view of an intumescent flame-retardant cable according to one embodiment of the present application; and

FIG. 5A and FIG. 5B illustrate cross-sectional schematic views of an intumescent flame-retardant cable according to one embodiment of the present application when horizontal burning occurs during a fire occurrence as compared with a cable having only a thermal expansion layer.

### REFERENCE NUMBERS OF THE ACCOMPANYING DRAWINGS:

1—intumescent flame-retardant coiled material for cables; 2—thermal expansion layer; 3—combustible armor layer; 4—metal wire layer; 5—metal wire; 6—intumescent flame-retardant cable; 7—cable core; 8—flame

### DETAILED DESCRIPTION

The present application will be further described in detail below in conjunction with the embodiments with reference to the drawings. It will be appreciated that other embodiments are considered and may be implemented without departing from the scope and spirit of the present application. Therefore, the following detailed description is non-limiting.

According to one aspect of the present application, the present application provides an intumescent flame-retardant coiled material for cables. The intumescent flame-retardant coiled material for cables includes a thermal expansion layer, and a sacrificial or combustible armor layer adjacent to the thermal expansion layer.

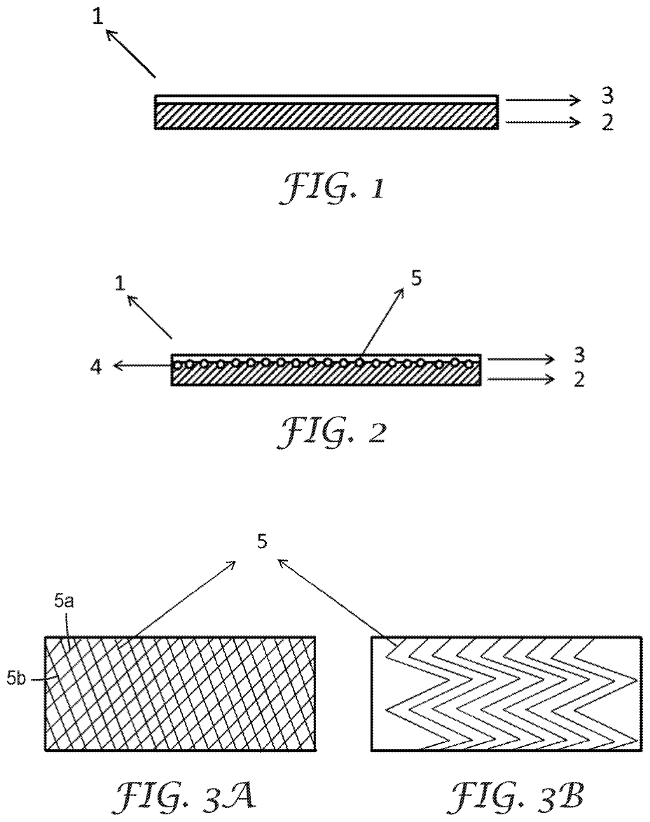

Specifically, FIG. 1 illustrates a cross-sectional view of an intumescent flame-retardant coiled material according to one embodiment of the present application. The intumescent flame-retardant coiled material 1 for cables includes a thermal expansion layer 2 and a combustible armor layer 3 adjacent to the thermal expansion layer.

According to the technical solution of the present application, the intumescent flame-retardant coiled material for cables is applied (for example, adhered) to a mounted or to-be-mounted cable (for example, straight cable or curved cable). The sacrificial or combustible armor layer has necessary mechanical properties and can provide necessary mechanical protection for the cable. Moreover, importantly, the combustible armor layer can burn when the cable is on fire and burns horizontally in the direction parallel to the cable length direction to effectively activate the expansion of the thermal expansion layer, thereby improving flame-retardant performance.

Preferably, thickness of the combustible armor layer is in a range from 1 mm to 10 mm. On one hand, when thickness of the combustible armor layer is less than 1 mm, the mechanical protection that can be provided by the combustible armor layer is insufficient in allowing the cable to resist various mechanical damages during daily use. On the other hand, when thickness of the combustible armor layer is greater than 10 mm, the combustible armor layer will take a long time to burn out when the cable is on fire, such that the expansion of the thermal expansion layer cannot be effectively activated and the flame-retardant performance is poor. There is no special restriction on the specific material of the combustible armor layer that can be used in the present application, as long as it can provide basic mechanical performance and can be burned out when the cable is on fire.

The specific material of the combustible armor layer may be reasonably selected by those skilled in the art according to the above requirement. Preferably, the combustible armor layer is an organic fiber combustible armor layer capable of providing mechanical performance and burn when the cable is on fire, thereby activating the expansion of the thermal expansion layer. An exemplary organic fiber combustible armor layer may comprise an organic fiber fabric coated with water-curable polyurethane resin that is curable at room temperature. The organic fiber is, for example, polyethylene terephthalate fiber such as KNT KCP04 polyester fiber casting tape available from Suzhou Connect Medical Technology Company, LTD (China). Other preferable armor layer materials can include a knitted fiberglass fabric impregnated with moisture activated polyurethane resin. The specific product of the combustible armor layer that can be used in the present application is a medical water-curable bandage (Product number: Scotchcast Plus Casting Tape 82001) produced by 3M Company.

According to the technical solution of the present application, the thermal expansion layer is the main flame-retardant component of the intumescent flame-retardant coiled material for cables. In one aspect, the thermal expansion layer comprises an intumescent material such as expandable graphite, expandable vermiculite, expandable microspheres, hydrated alkali metal silicates, vermiculite, perlite, sodium boron silicate materials, volcanic glass with CO2 blowing agent incorporated within the glass particles, mica, and mixtures thereof in a polymeric binder. The intumescent materials is present in an amount ranging from at least about 5 weight %, preferably about 5 weight % to about 85 weight %, more preferably 9 weight % to about 75 weight %, based on the total weight % of the thermal expansion layer. Exemplary polymeric binders are generally elastomeric materials such as can be polyurethane materials, polyvinylchloride materials, rubber materials, silicone materials and the like. The polymeric binder is present in an amount ranging from at least about 15 weight %, preferably about 15 weight % to about 95 weight %, more preferably 25 weight % to about 91 weight %, based on the total weight % of the thermal expansion layer. In some exemplary embodiments, the thermal expansion layer can further comprise a carrier material to support the intumescent material disposed on the polymeric binder. Exemplary carrier materials can be fibrous mats or scrims, polymeric film and the like.

When the cable is on fire, the combustible armor layer burns horizontally in the direction parallel to the cable length direction, effectively activating the expansion of the thermal expansion layer creating an expansion body and thus achieving the flame-retardant effect. Preferably, thickness of the thermal expansion layer is in a range from 1 mm to 20 mm. On one hand, when thickness of the thermal expansion layer is less than 1 mm, the expansion of the thermal expansion layer during burning is too small to effectively achieve the flame-retardant effect. On the other hand, for the purpose of economy and convenience in operation, thickness of the thermal expansion layer is no greater than 20 mm. No special restriction exists on the specific material of the thermal expansion layer that can be used in the present application. A conventional material that is usually used in the field for flame retardancy by expansion may be used. Preferably, the thermal expansion layer is a phosphate thermal expansion layer, a melamine thermal expansion layer, a ceramic fiber thermal expansion layer, or an expandable graphite thermal expansion layer. Exemplary examples of materials for the thermal expansion layer that can be used in the present application includes Scotch® Fire-Retardant and Electric Arc Proofing Tape 77 Series produced by 3M Company (St. Paul, Minn., USA); 3M™ Fire Barrier Ultra GS Wrap Strip produced by 3M Company; and 3M™ Interam™ Mat I-10 from 3M Company (St. Paul, Minn., USA).

According to one preferred embodiment of the present application, a metal wire layer is further provided between the thermal expansion layer and the combustible armor layer. FIG. 2 illustrates a cross-sectional view of an intumescent flame-retardant coiled material according to another embodiment of the present application. The intumescent flame-retardant coiled material 1 for the cable includes a thermal expansion layer 2; a combustible armor layer 3 adjacent to the thermal expansion layer; and a metal wire layer 4 between the thermal expansion layer 2 and the combustible armor layer 3. The metal wire layer 4 consists of metal wires 5. The function of the metal wire layer 4 is as follows: (1) when the cable is on fire, the metal wire layer can quickly transfer the heat to the adjacent area, so as to facilitate the expansion of the expandable material in the adjacent area; (2) the local area in the intumescent flame-retardant coiled material for cables is prevented from being overheated; and (3) when the expandable material at the lower part of the metal wire layer expands, the metal wire layer can expand along with it and can hold the expansion body, so as to prevent it peeling off from the cable, thus better ensuring the fireproof effect. No special restriction exists on the arrangement of the metal wire layer between the thermal expansion layer and the combustible armor layer, as long as it can achieve the above technical effect. FIG. 3 illustrates top perspective views A and B of an intumescent flame-retardant coiled material for cables according to one embodiment of the present application, which respectively illustrate an X-shaped or crossing arrangement and a Z-shaped or zig-zag arrangement of the metal wires 5.

As illustrated in FIG. 3A, in the X-shaped arrangement, two groups of metal wires 5 parallel to each other are arranged crossing with each other. In other words, a first group of parallel wires 5a are disposed in a first direction relative to the intumescent flame-retardant coiled material, and a second group of parallel wires 5b are disposed in a second direction relative to the intumescent flame-retardant coiled material such that the first group of parallel wires and the second group of parallel wires cross. In an exemplary aspect, the wire layer can comprise a woven wire mesh.

As illustrated in FIG. 3B, the metal wire layer comprises a plurality of substantially metal wires disposed in a Z-shaped or zig-zag arrangement, such that the metal wires 5 arranged in a Z-shape or zig-zag arrangement do not cross each other.

Preferably, the diameter of a metal wire in the metal wire layer is in a range from 0.01 mm to 0.5 mm. An average spacing between two adjacent parallel metal wires in the metal wire layer is in a range from 2 mm to 10 mm. When the diameter of the metal wire in the metal wire layer and the average spacing between two adjacent parallel metal wires are selected to be in the above ranges, the following effects can be achieved without using excessive metal wires: good heat transfer, preventing overheating of the local area, and stabilizing the shape of the expansion body.

According to another aspect of the present application, the present application provides an intumescent flame-retardant cable. The intumescent flame-retardant cable is produced by wrapping the exemplary intumescent flame-retardant coiled material around a cable to provide mechanical protection performance and flame-retardant performance. The intumescent flame-retardant cable includes a cable core, a thermal expansion layer disposed adjacent to the cable core, and a combustible armor layer adjacent to the thermal expansion layer.

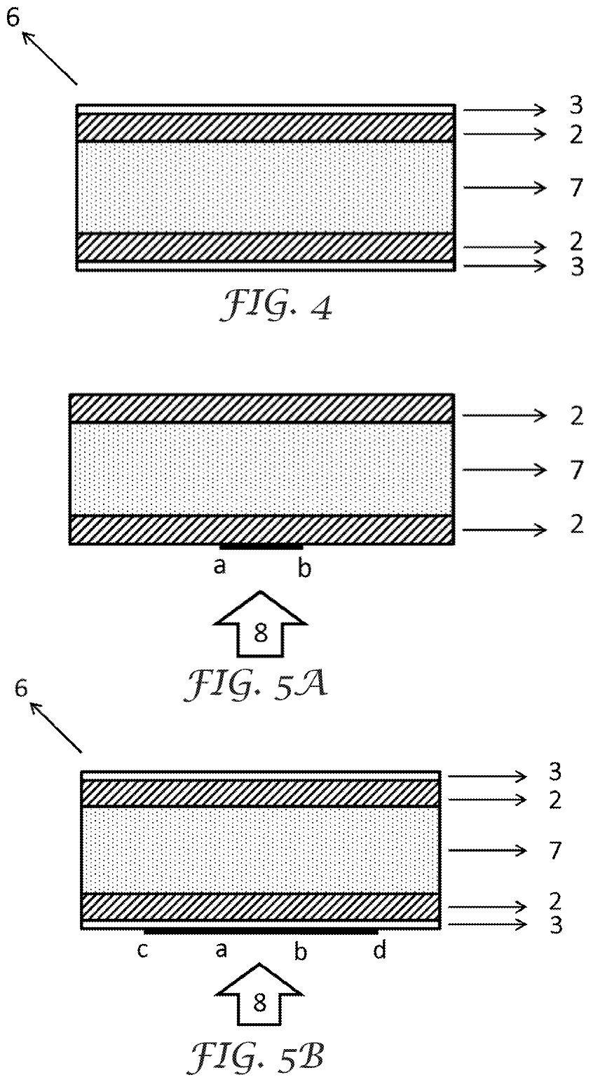

FIG. 4 illustrates a cross-sectional view of an intumescent flame-retardant cable 6 according to one embodiment of the present application. The intumescent flame-retardant cable 6 includes a cable core 7; a thermal expansion layer 2 adjacent to the cable core 7; and a combustible armor layer 3 adjacent to the thermal expansion layer 2.

No special restriction exists on the cable core 7 that can be used in the present application. The cable may be made of various cable materials commonly used in the electrical field, including copper core power cables, aluminum core power cables, plastic insulated power cables, rubber insulated power cables, and the like.

Regarding the detailed description of the thermal expansion layer 2, the combustible armor layer 3, and the metal wire layer 4 that can exist in the intumescent flame-retardant cable 6, please refer to the above description of the thermal expansion layer 2, the combustible armor layer 3, and the metal wire layer 4 in the intumescent flame-retardant coiled material for cables, which will not be described again herein.

According to the technical solution of the present application, the combustible armor layer has necessary mechanical properties and can provide necessary mechanical protection for the cable. Moreover, the combustible armor layer can burn when the cable is on fire and burns horizontally in the direction parallel to the cable length direction, effectively activating the expansion of the thermal expansion layer and improving flame-retardant performance. FIG. 5A illustrates cross-sectional schematic views of a conventional intumescent flame-retardant cable and FIG. 5B illustrates cross-sectional schematic views of an intumescent flame-retardant cable according to one embodiment of the present application when horizontal burning occurs during a fire occurrence as compared with a cable having only a thermal expansion layer.

Specifically, FIG. SA illustrates a cross-sectional schematic view of a conventional method of improving the flammability of a cable wherein the protected cable consists of only a cable core 7 and a thermal expansion layer 2 covering the cable core 7 when burning occurs during a fire occurrence. When a flame 8 is located under the cable, expansion of the thermal layer will occur only the area between point a and point b, thus making the flame-retardant effect not ideal.

FIG. 5B illustrates a cross-sectional schematic view of an intumescent flame-retardant cable 6 according to one embodiment of the present application when horizontal burning occurs during a fire occurrence. Intumescent flame-retardant cable 6 is formed by wrapping the exemplary intumescent flame-retardant coiled material around a cable to provide improved mechanical protection performance and flame-retardant performance. Because the intumescent flame-retardant coiled material is provided in roll form and applied by wrapping it can be applied to a cable core in the field even after a cable has been mounted or is in a curved configuration.

The intumescent flame-retardant cable 6 includes a cable core 7; a thermal expansion layer 2 adjacent to the cable core 7; and a combustible armor layer 3 adjacent to the thermal expansion layer 2. When the flame 8 is located under the intumescent flame-retardant cable 6, the combustible armor layer 3 burns horizontally in the length direction of the intumescent flame-retardant cable 6. The burning position includes not only the area between point a and point b, but also the area between point c and point d. Therefore, the horizontal burning of the combustible armor layer 3 increases the expansion rate of the thermal expansion layer 2 below, thus significantly improving the flame-retardant effect.

The selected embodiments of the present disclosure include, but are not limited to, the following:

In embodiment 1, the present disclosure provides an intumescent flame-retardant coiled material for cables. The intumescent flame-retardant coiled material for cables includes:
a thermal expansion layer; and
a combustible armor layer adjacent to the thermal expansion layer.

In embodiment 2, the present disclosure provides an intumescent flame-retardant coiled material for cables according to embodiment 1, wherein thickness of the thermal expansion layer is in a range from 1 mm to 20 mm.

In embodiment 3, the present disclosure provides an intumescent flame-retardant coiled material for cables according to embodiment 1, wherein thickness of the combustible armor layer is in a range from 1 mm to 10 mm.

In embodiment 4, the present disclosure provides an intumescent flame-retardant coiled material for cables according to embodiment 1, wherein the thermal expansion layer is a phosphate thermal expansion layer, a melamine thermal expansion layer, a ceramic fiber thermal expansion layer, or an expandable graphite thermal expansion layer.

In embodiment 5, the present disclosure provides an intumescent flame-retardant coiled material for cables according to embodiment 1, wherein the combustible armor layer is an organic fiber combustible armor layer or a knitted fiberglass layer impregnated with a polyurethane resin.

In embodiment 6, the present disclosure provides an intumescent flame-retardant coiled material for cables according to embodiment 1, wherein a metal wire layer is further provided between the thermal expansion layer and the combustible armor layer.

In embodiment 7, the present disclosure provides an intumescent flame-retardant coiled material for cables according to claim 6, wherein the metal wire layer comprises two groups of metal wires wherein wires in each group are arranged substantially parallel to other wires in the group and wherein the groups of wires are arranged such that the wires within the two groups cross.

In embodiment 8, the present disclosure provides an intumescent flame-retardant coiled material for cables according to claim 6, wherein the metal wire layer comprises a plurality of substantially metal wires parallel are disposed in a zigzag shape.

In embodiment 9, the present disclosure provides an intumescent flame-retardant coiled material for cables according to embodiment 6, wherein the diameter of a metal wire in the metal wire layer is in a range from 0.01 mm to 0.5 mm.

In embodiment 10, the present disclosure provides an intumescent flame-retardant coiled material for cables according to any one of embodiment 6 to embodiment 9, wherein an average spacing between two adjacent parallel metal wires in the metal wire layer is in a range from 2 mm to 10 mm.

In embodiment 11, the present disclosure provides an intumescent flame-retardant cable. The intumescent flame-retardant cable includes:
a cable core;
a thermal expansion layer adjacent to the cable core; and
a combustible armor layer adjacent to the thermal expansion layer.

In embodiment 12, the present disclosure provides an intumescent flame-retardant cable according to embodiment 11, wherein thickness of the thermal expansion layer is in a range from 1 mm to 20 mm.

In embodiment 13, the present disclosure provides an intumescent flame-retardant cable according to embodiment 11, wherein thickness of the combustible armor layer is in a range from 1 mm to 10 mm.

In embodiment 14, the present disclosure provides an intumescent flame-retardant cable according to embodiment 11, wherein the thermal expansion layer is a phosphate thermal expansion layer, a melamine thermal expansion layer, a ceramic fiber thermal expansion layer, or an expandable graphite thermal expansion layer.

In embodiment 15, the present disclosure provides an intumescent flame-retardant cable according to embodiment 11, wherein the combustible armor layer is an organic fiber combustible armor layer or a knitted fiberglass layer impregnated with a polyurethane resin.

In embodiment 16, the present disclosure provides an intumescent flame-retardant cable according to embodiment 11, wherein a metal wire layer is further provided between the thermal expansion layer and the combustible armor layer.

In embodiment 17, the present disclosure provides an intumescent flame-retardant coiled material for cables according to claim 16, wherein the metal wire layer comprises two groups of metal wires wherein wires in each group are arranged substantially parallel to other wires in the group and wherein the groups of wires are arranged such that the wires within the two groups cross.

In embodiment 18, the present disclosure provides an intumescent flame-retardant coiled material for cables according to claim 16, wherein the metal wire layer comprises a plurality of substantially metal wires parallel are disposed in a zigzag shape.

In embodiment 19, the present disclosure provides an intumescent flame-retardant cable according to embodiment 16, wherein the diameter of a metal wire in the metal wire layer is in a range from 0.01 mm to 0.5 mm.

In embodiment 20, the present disclosure provides an intumescent flame-retardant cable according to any one of embodiment 16 to embodiment 19, wherein an average spacing between two adjacent parallel metal wires in the metal wire layer is in a range from 2 mm to 10 mm.

While the description has primarily focused on improving the mechanical and flame performance of cables, the exemplary intumescent flame-retardant coiled material, described herein, can also be directly applied onto mounted or installed cable splices or other installed assets where additional mechanical performance and flame resistance is desired.

It will be apparent to those skilled in the art that various modifications and variations can be made to the present disclosure without departing from the spirit and scope of the present disclosure. Thus, if these modifications and variations to the content of the present disclosure fall within the scope of the claims of the present invention and its equivalent technical solutions, the content of the present disclosure is also intended to include these modifications and variations.

### EXAMPLES

### Torch Flammability Test Method

A propane torch adjusted to have a flame temperature of 500-650° C. was applied to around the diameter of a 4.5 cm protected cable section for 5 minutes. The degree of expansion and condition of the cable were noted. If there were signs of damage to the cable core, the sample failed the test.

### Mechanical Performance Test Method

The test specimen is prepared spiral wrapping a total of four layers of the sample to be tested onto a stainless steel cylinder which has a diameter of 6.0 cm and a length of 30.5 cm so that the sample material layer covers 23-25 cm of the cylinder. The sample is stored at room temperature for 24 hours to allow the sample material to cure. After 24 hours the cured sleeve of the sample material is removed from the stainless steel cylinder. If needed, a stockinet sleeve, such as 3M™ Synthetic Cast Stockinet available from 3M Company (St. Paul, Minn., USA), may be placed on the stainless steel cylinder prior to the application of the sample material to facilitate removal of the sample material sleeve from the stainless steel cylinder.

A 5960 Series Universal Testing System, available from INSTRON (Norwood, Mass., USA) is equipped with a three-point bend test fixture configured to hold the cylindrical sleeve. The test sample is centered on and perpendicular to the two supports disposed 3 inches (7.62 cm) of the base member of the test fixture. The aluminum top member is allowed to contact the sample at its center at a rate of 1 inch (2.54 cm)/minute to a total deflection of one inch (2.54 cm). The test result is taken as that force which results from the resistance imparted by the sample at the maximum deflection point of one-inch.

Samples wrapped only with an intumescent material had very low strength and were not self-supporting once removed from the steel cylinder, while the examples with an armor layer each had a strength between 500-600N.

### Comparative Examples C1-C3

Comparative example C1: A cable was wrapped with a layer of an intumescent material available as 3M™ Interam™ Mat I-10 from 3M Company (St. Paul, Minn., USA) with a 1-inch (2.54 cm) overlap. The intumescent layer was fixed in place at the ends with glass tape. The wrapped cable was subjected to the torch flammability test. 100% expansion of the intumescent material occurred in the area directly exposed to the flame with very limited expansion outside of the flame exposure area. The thickness of 3M™ Interam™ Mat I-10 was 5 mm. Thus, the nominal thickness of the protective layer is about 5 mm with the overlap regions having a thickness up to 10 mm.

Comparative example C2: A cable was wrapped using a level winding technique with a layer of an armor material available 3M™ Armorcast Structural Material 4560 from 3M Company (St. Paul, Minn., USA). The samples were misted with water to activate the cure of the armor layer. The sample was held at ambient temperature for 24 hours to let the armor layer cure and dry prior to subjecting the sample to the torch flammability test. The armor material survived the torch test. However, the flame penetrated through the armor layer damaging the cable beneath. The thickness of armor layer was 3.0 mm. Thus, the nominal thickness of the protective layer is about 3 mm with the overlap regions having a thickness up to 6 mm.

Comparative example C3: A cable was wrapped using a level winding technique with a layer of an intumescent material available as 3M™ Interam™ Mat I-10 from 3M Company (St. Paul, Minn., USA) and overwrapped with a glass cloth armor layer (3M™ Armorcast Structural Material 4560 from 3M Company (St. Paul, Minn., USA)). The samples were misted with water to activate the cure of the armor layer. The sample was held at ambient temperature for 24 hours to let the armor layer cure and dry prior to subjecting the sample to the torch flammability test. The glass fiber based armor survived the flame test, which limited or negligible expansion of the intumescent layer. The thickness of 3M™ Interam™ Mat I-10 was 5 mm and the thickness of the armor material was 3.0 mm. Thus, the nominal thickness of the protective layer is about 8 mm with the overlap regions having a thickness up to 16 mm.

### Examples EX1-EX3

Example EX1: A cable was wrapped using a level winding technique with intumescent flame-retardant material available as 3M™ Interam™ Mat I-10 from 3M Company (St. Paul, Minn., USA) and then over wrapped with a sacrificial armor layer (3M™ Scotchcast™ Plus Casting Tape 82001, 3M company, St. Paul, Minn., USA). The samples were misted with water to activate the cure of the armor layer. The sample was held at ambient temperature for 24 hours to let the armor layer cure and dry prior to subjecting the sample to the torch flammability test. 100% expansion of the intumescent material occurred in the area directly exposed to the flame with 20-30% expansion of the intumescent material extending 2-3 cm beyond the flame exposure area due to the horizontal burning of the sacrificial armor layer. The flame temperature in the flame exposure are was 500-650° C. while the flame temperature in the horizontal burning portion was 350-430° C., which was sufficient to activate the expansion of the intumescent layer. The thickness of 3M™ Interam™ Mat I-10 is 5 mm, while the thickness of armor material is 4.0 mm Thus, the nominal thickness of the protective layer is about 9 mm with the overlap regions having a thickness up to 18 mm.

Example EX2: A cable was wrapped using a level winding technique with intumescent flame-retardant material available as 3M™ Interam™ Mat I-10 from 3M Company (St. Paul, Minn., USA). A woven wire layer (Scotch® Electrical Grounding Braid 24 available from 3M company, St. Paul, Minn., USA) was wrapped over the intumescent layer the and then a sacrificial armor layer (3M™ Scotchcast™ Plus Casting Tape 82001, 3M company, St. Paul, Minn., USA) was wrapped over the wire layer. The samples were misted with water to activate the cure of the armor layer. The sample was held at ambient temperature for 24 hours to let the armor layer cure and dry prior to subjecting the sample to the torch flammability test. 100% expansion of the intumescent material occurred in the area directly exposed to the flame with 50-100% expansion of the intumescent material extending 4-5 cm beyond the flame exposure area due to the horizontal burning of the armor layer and the conduction of the heat by the metal wires. The flame temperature in the flame exposure are was 500-650° C. while the flame temperature in the horizontal burning portion was 350-430° C., which was sufficient to activate the expansion of the intumescent layer. Advantageously, the woven wire layer helped hold the frangible expanded intumescent layer in place after the armor layer was burned away. The thickness of 3M™ Interam™ Mat I-10 was 5 mm; the thickness of armor material was 4.0 mm; and thickness of woven wire layer was 0.8 mm. Thus, the nominal thickness of the protective layer is about 10 mm with the overlap regions having a thickness up to 20 mm.

Example EX3: A dual layer material was prepared by coating an intumescent composition onto a sacrificial armor layer. The intumescent composition was prepared by mixing expandable graphite into curable urethane matrix comprising (ADT 1002 from Shijiazhuang ADT carbonic material factory (China)) into curable urethane matrix comprising a 1:1 mixture of WANEFOAM® RCP5 Polyol and WANNATE® PM200 polymeric MDI (methylene diphenyl diisocyanate), both of which are available from Wanhua Chemical Group (China). The weight ratio of expandable graphite to polyurethane matrix was 2:1.

The intumescent composition was coated onto a sacrificial armor layer (3M™ Scotchcast™ Plus Casting Tape 82001, 3M company, St. Paul, Minn., USA) and cured to form a dual layer intumescent flame-retardant coiled material.

The dual layer intumescent flame-retardant coiled material was wrapped onto a cable using a level winding technique. The samples were misted with water to activate the cure of the armor layer. The sample was held at ambient temperature for 24 hours to let the armor layer cure and dry prior to subjecting the sample to the torch flammability test. The protected cable was subjected to the torch flammability test. 200% expansion of the intumescent material occurred in the area directly exposed to the flame with 50-100% expansion of the intumescent material extending 4-5 cm outside of the flame exposure area due to the horizontal burning of the armor layer. The flame temperature in the flame exposure are was 500-650° C. while the flame temperature in the horizontal burning portion was 350-430° C., which was sufficient to activate the expansion of expansible graphite in the coiled material.

The thickness of dual layer intumescent flame-retardant coiled material was 5.5 mm. Thus, the nominal thickness of the protective layer is about 5.5 mm with the overlap regions having a thickness up to 11 mm.

1. An intumescent flame-retardant coiled material for cables, the intumescent flame-retardant coiled material for cables comprising:
a thermal expansion layer; and
a combustible armor layer adjacent to the thermal expansion layer,
wherein the thermal expansion layer is a phosphate thermal expansion layer, a melamine thermal expansion layer, a ceramic fiber thermal expansion layer, or an expandable graphite thermal expansion layer and, wherein the combustible armor layer is an organic fiber combustible armor layer or a knitted fiberglass layer impregnated with a polyurethane resin.

2. The intumescent flame-retardant coiled material for cables according to claim 1, wherein thickness of the thermal expansion layer is in a range from 1 mm to 20 mm.

3. The intumescent flame-retardant coiled material for cables according to claim 1, wherein thickness of the combustible armor layer is in a range from 1 mm to 10 mm.

4. The intumescent flame-retardant coiled material for cables according to claim 1, wherein a metal wire layer is further provided between the thermal expansion layer and the combustible armor layer.

5. The intumescent flame-retardant coiled material for cables according to claim 4, wherein the metal wire layer comprises two groups of metal wires wherein wires in each group are arranged substantially parallel to other wires in the group and wherein the groups of wires are arranged such that the wires within the two groups cross.

6. The intumescent flame-retardant coiled material for cables according to claim 4, wherein the metal wire layer comprises a plurality of substantially metal wires parallel are disposed in a zigzag shape.

7. The intumescent flame-retardant coiled material for cables according to claim 4, wherein the diameter of a metal wire in the metal wire layer is in a range from 0.01 mm to 0.5 mm.

8. The intumescent flame-retardant coiled material for cables according to claim 4, wherein an average spacing between two adjacent parallel metal wires in the metal wire layer is in a range from 2 mm to 10 mm.

9. The intumescent flame-retardant coiled material for cables according to claim 1, wherein the combustible armor layer is a knitted fiberglass layer impregnated with a polyurethane resin.

10. An intumescent flame-retardant cable, the intumescent flame-retardant cable comprising:
a cable core;
a thermal expansion layer adjacent to the cable core; and
a combustible armor layer adjacent to the thermal expansion layer,
wherein the thermal expansion layer is a phosphate thermal expansion layer, a melamine thermal expansion layer, a ceramic fiber thermal expansion layer, or an expandable graphite thermal expansion layer and, wherein the combustible armor layer is an organic fiber combustible armor layer or a knitted fiberglass layer impregnated with a polyurethane resin.

11. The intumescent flame-retardant cable according to claim 10, wherein thickness of the thermal expansion layer is in a range from 1 mm to 20 mm.

12. The intumescent flame-retardant cable according to claim 10, wherein thickness of the combustible armor layer is in a range from 1 mm to 10 mm.

13. The intumescent flame-retardant cable according to claim 10, wherein a metal wire layer is further provided between the thermal expansion layer and the combustible armor layer.

14. The intumescent flame-retardant cable according to claim 13, wherein the metal wire layer comprises two groups of metal wires, wherein wires in each group are arranged substantially parallel to other wires in the group and wherein the two groups of wires are arranged such that the wires within the two groups cross.

15. The intumescent flame-retardant cable according to claim 13, wherein the metal wire layer comprises a plurality metal wires arranged parallel to each other and in a Z-shape configuration without crossing with other wires.

16. The intumescent flame-retardant cable according to claim 13, wherein the diameter of a metal wire in the metal wire layer is in a range from 0.01 mm to 0.5 mm.

17. The intumescent flame-retardant cable according to claim 13, wherein an average spacing between two adjacent parallel metal wires in the metal wire layer is in a range from 2 mm to 10 mm.

18. The intumescent flame-retardant cable according to claim 10, wherein the combustible armor layer is a knitted fiberglass layer impregnated with a polyurethane resin.
